(19) United States
(12) Patent Application Publication
(10) Pub. No.: US 2024/0209833 A1
(43) Pub. Date: Jun. 27, 2024

(54) METHOD FOR OPERATING A WIND POWER INSTALLATION AT INCREASED POWER

(71) Applicant: Wobben Properties GmbH, Aurich (DE)

(72) Inventors: Hussam Daboul, Südbrookmerland (DE); Annika Länger-Möller, Aurich (DE); Jochen Stemberg, Aurich (DE)

(21) Appl. No.: 18/391,787

(22) Filed: Dec. 21, 2023

(30) Foreign Application Priority Data
Dec. 23, 2022 (EP) 22216455.0

(51) Int. Cl. F03D 7/02

(52) U.S. Cl. CPC F03D 7/028; F05B 2270/1033; F05B 2270/301; F05B 2270/303; F05B 2270/32

(57) ABSTRACT

Provided is a method for controlling a wind power installation having an aerodynamic rotor which is operable at variable speed and which has rotor blades which are adjustable in terms of their blade angle, and having a generator for generating a generator power, the wind power installation being distinguished by a nominal speed, a nominal power and a nominal wind speed at which the nominal speed and the nominal power are reached, and the method comprises: for a wind speed above the nominal wind speed, operating the wind power installation at a power above the nominal power, the power being above the nominal power by a boost power, the wind power installation being operated in such a way that a flapwise torque remains below a predeterminable limit torque, and a prevailing power loss does not exceed a predeterminable power loss limit.

### BACKGROUND

### Technical Field

Embodiments of the present invention relate to a method for controlling a wind power installation. Embodiments of the present invention relate to a corresponding wind power installation.

### Description of the Related Art

Wind power installations are known; they generate electrical power from wind. If the wind speed is below a nominal wind speed, the wind power installation operates in part-load operation. During this part-load operation, an attempt is made to operate the wind power installation optimally such that it draws as much power as possible from the wind.

However, if the wind speed reaches nominal wind speed and even rises above it, full-load operation occurs and the wind power installation is operated in such a way that overloading is avoided, which overloading could otherwise result in the wind power installation being damaged and/or could reduce the service life of the wind power installation. For this purpose, it is intended to operate the wind power installation, upward of nominal wind speed, at a nominal speed and a nominal power. The speed is thus limited to the nominal speed and the power is limited to the nominal power. The speed can also synonymously be referred to as the rotor speed. The power here can be the generator power output by the generator, or the installation power specified by the wind power installation. Particularly for steady-state operation, these two powers are essentially the same and essentially differ only by power loss. Hereinbelow, it suffices to consider one of these two powers.

In order to increase the yield from the wind power installation further still, it would be desirable to be able to generate a little more power than the nominal power, if enough wind is available.

The underlying idea here is that although the wind power installation is designed for nominal power and nominal speed, this design may be based on assumptions which can change. In particular, a temperature of components is a limiting variable. If components overheat, they and therefore the wind power installation may be damaged and the service life of the wind power installation may respectively be reduced. Increasing the installation power above the nominal power can thus come into consideration if it is however ensured in this case that temperature limits are not exceeded. Particularly, increasing the power above the nominal power may come into consideration if low outside temperatures are present so that the components are altogether cooled in a better way.

However, components may also be damaged for reasons other than excessive temperature and it is also not possible to monitor the temperature of every component. Operating the wind power installation at a higher power than the nominal power and/or at a higher speed than the nominal speed is thus a risk which ought to be avoided or reduced.

### BRIEF SUMMARY

Some embodiments provide a solution by way of which the yield from the wind power installation can be increased. Some embodiments provide a solution by way of which the wind power installation can be operated at higher power than the nominal power without, however, thereby risking damage to the wind power installation or an undesired reduction in the lifetime thereof.

A method is provided for controlling a wind power installation having an aerodynamic rotor which is operable at variable speed and which has rotor blades which are adjustable in terms of their blade angle, and having a generator for generating a generator power, the wind power installation being distinguished by a nominal speed, a nominal power and a nominal wind speed at which the nominal speed and the nominal power, respectively, are reached. The speed of the aerodynamic rotor can also be referred to as the rotor speed. During part-load operation, the speed and power increase on the basis of the wind speed until they have reached nominal speed and nominal power, respectively, at nominal wind speed.

It is now proposed, for a wind speed above the nominal wind speed, that the wind power installation be operated at a power above the nominal power. In this case, the power is above the nominal power by a boost power. The power refers particularly to an installation power for which the nominal power is also provided. The power is then above the nominal power by a boost power. However, the generator power, which may be a little below the installation power, can also be used as a basis, it being possible for the generator to be accordingly distinguished by a generator nominal power, which is accordingly a little below the nominal power, that is to say the nominal power of the wind power installation, that is to say the nominal power of the installation power. In each case, the power, whichever of the two is considered, is above the respectively applicable nominal power by the boost power.

The wind power installation is thus operated at a higher power than intended. In this case, however, the wind power installation is operated in such a way that a flapwise torque remains below a predeterminable limit torque. Moreover, provision is made for the prevailing power loss not to exceed a predeterminable power loss limit. The flapwise torque, which can also be referred to as the blade flapwise torque, refers to a torque at the blade root of the rotor blade in question, which torque is basically directed toward the pressure side of the rotor blade, that is to say transverse to the blade chord. At a blade angle of 0°, said torque is directed in the axial direction of the rotor axis; at a blade angle of 90°, it is directed in the rotational direction of the rotor. In other words, said torque is a force which the wind exerts on the rotor blade in the mentioned direction. This force can be spread out over the rotor blade and results in a bending torque, which forms this flapwise torque, at the blade root where the blade is fastened to a rotor hub. This bending torque or flapwise torque can also be considered to be rotary torque, even though no rotation arises in this direction since the rotor blade is fixedly connected to the hub there. To put it clearly, the flapwise torque thus results in a bending torque acting on the rotor axis. The effect that the flapwise torque has on the rotor axis depends on the blade angle.

It has been particularly recognized here that this mechanical load is an important variable that needs to be limited when the installation is operated at a power above the nominal power. It has also been recognized here that this flapwise torque, and also its effect, that is to say the bending in the direction of the rotor axis, depends to a great extent on the prevailing blade angle. This flapwise torque may be maximal at nominal wind speed because a comparatively strong wind is present at nominal wind speed, namely nominal wind, but while the rotor blades, that is to say also each individual rotor blade respectively considered, are not yet rotated out of the wind. Only when the wind speed increases, that is to say to above the nominal wind speed, are the rotor blades rotated out of the wind. This reduces the load on the blades in the direction of the rotor axis.

It has thus been recognized that it is not possible for thermal observation to reflect this situation. In particular if the wind speed increases further, this flapwise torque can be reduced by rotating the rotor blades out of the wind. However, this does not reduce other loads on the wind power installation. Particularly during operation of the wind power installation at nominal power or above, the thermal loading essentially depends on the generated power. The change in the flapwise torque, and therefore in the mechanical loading directly associated therewith, is barely deducible from the temperature of components.

However, generating the power also results in power loss, and this should not exceed a predeterminable power loss limit. Considering the power loss is thus additionally considering that no excessive thermal loading occurs. If the power is raised above the nominal power, the power loss increases too. The power loss is thus an indicator of the electrical power and therefore of the electrical load on the wind power installation. The thermal load on the wind power installation can also be observed indirectly via the power loss. In this case, observing the power loss makes it possible to observe the thermal load on the whole, instead of selectively observing individual thermal loads by monitoring the temperature of components.

These proposals thus allow the wind power installation to be operated, even continuously, above nominal power so long as the monitored criteria are met. It therefore needs to be ensured that the flapwise torque is kept below a predeterminable limit torque and that the prevailing power loss is not allowed to exceed a predeterminable power loss limit. As a result, it is possible to increase yield without the service life being shortened or significantly shortened and in particular without the wind power installation being damaged.

According to one aspect, it is proposed that, provided that the wind speed is sufficiently high, the wind power installation is continuously operated at a power above the nominal power, in particular over a period of at least 10 minutes, in particular of at least one hour. Additionally or alternatively, it is proposed that the boost power is at least 1% of the nominal power, preferably at least 5% and in particular at least 8%. Boosting by a boost power of 1% is already considered to be significant; the high investment costs should be borne in mind. If the wind power installation is operated only at 1% more than the nominal power, this would be equivalent to an additional hour over four days. However, the boost power is preferably at least 5% higher than the nominal power. Mathematically, this would be equivalent to additional operation of a further year over a typical lifetime of 20 years. In particular, it is proposed that the boost power is at least 8% of the nominal power. It has been recognized here that even a boost by 8% is possible if the flapwise load is not too great and the power loss is likewise not too great, that is to say both of the mentioned limit values are complied with.

In particular, it has been recognized that not only is a very short-term boost possible, which, e.g., would come into consideration for supporting a network demand, but also a longer-term boost which spans at least over 10 minutes, in particular can last over one hour. Of course, the prerequisite here is always that enough wind is present. The yield can therefore be significantly increased by such a continuous or at least longer-term boost in the power.

According to one aspect, it is proposed that while the wind power installation is being operated at the power above the nominal power, the speed is regulated to nominal speed. It has been recognized here that even a very high speed can be a load for the wind power installation; operation at increased power is also possible without increasing the speed, however. Loads which may occur due to a high speed are taken into consideration in that the speed does not increase to above nominal speed.

According to one aspect, it is proposed that, during operation of the wind power installation at a power above the nominal power, the power loss limit is determined on the basis of a cooling power, in particular the cooling power being estimated or being calculated using a calculation rule, and/or the cooling power for the generator and/or for further electrical components, in particular an electrical drive train, being determined.

The cooling power provides information about the extent to which components are thermally loaded. Cooling power here is particularly that which has to be actively applied in order to cool components, e.g., by way of fans or circulating pumps in liquid cooling, in particular water cooling. If such a cooling power increases, it is proposed to lower the power loss limit. On the one hand, this can prevent an excessive thermal load from occurring for the same power loss. On the other hand, there is also the danger that operating the wind power installation at increased power entails an increase in the power required for the active cooling until this required cooling power reaches or even exceeds the power additionally generated by the power boost.

The cooling power as a whole can be estimated or can be calculated using a calculation rule. It is particularly the case here that power applied for cooling, that is to say, e.g., the power consumption of a fan, does not necessarily have to be considered but rather the cooling power can be read from other values. For example, when cooling with a cooling medium, the temperature of the cooling medium before it reaches the component that is to be cooled can be compared with the temperature that this cooling medium has after passing the component that is to be cooled. Together with the volume of the flow of this cooling medium, it is then possible to draw a good conclusion about the cooling power. An estimate can be used here, for example by virtue of a state observer being used, or direct calculation rules can be applied, which calculation rules can calculate the cooling power directly, e.g., on the basis of the two temperatures of the cooling medium and its volume flow in the above-mentioned example.

Additionally or alternatively, it is proposed that the cooling power for the generator is determined. The generator can be the element of the wind power installation that generates the most power loss. Therefore, if the cooling power for the generator is determined, the largest part of the cooling power is thus often determined on the one hand. Additionally, calculations and estimations of cooling power based on the element that requires the most cooling power are least susceptible to errors. The cooling power as a whole can additionally be inferred from the cooling power for the generator, e.g., based on empirical values or pre-recorded reference tables, that is to say taking into account further elements that require a cooling power. Information about such elements, e.g., temperature or power consumption of an electrical component of an inverter, can be stored in the reference table.

Additionally or alternatively, it is proposed to consider further components for which the cooling power is determined. This can improve the result. In particular, it is proposed to take electrical components of an electrical drive train into consideration. An electrical drive train denotes everything that is present electrically from the generator to the feeding-in, that is to say practically everything that the current flows through. This particularly includes a rectifier, an inverter and cables connecting these two elements. A line choke, provided that it is not considered to be an element of the inverter, can likewise be included and a transformer can also be included so far as it is part of the wind power installation.

Power losses occur here too. The rectifier and/or the inverter can particularly possess an active cooling system, in particular a fan in each case. The respective cooling power can be determined on the basis thereof. A connecting cable is typically not actively cooled; it can nevertheless provide information about a power loss which occurs in such a connecting cable. In principle, it also comes into consideration to take into account a small part of a cooling power for the cable. The cable may in particular output heat and, possibly due to cooling the interior of the wind power installation to which it outputs the heat, may indirectly result in a cooling power.

According to one aspect, it is proposed that the wind power installation is operated at a power above the nominal power in such a way, in particular the boost power is chosen in such a way that a generator torque does not exceed a predeterminable generator limit torque, and/or the generator torque is set in such a way that the generator limit torque is not exceeded, and in particular the generator limit torque is set on the basis of operational settings and/or environmental conditions.

It has been recognized in particular here that the torque, too, can be a limiting variable and can be particularly critical. At nominal speed, which is preferably intended to be complied with, a power above the nominal power is only possible with a generator torque above the nominal torque. The generator torque is therefore generally set to a very high value. The generator can, in principle, be operated even at a generator torque above the generator nominal torque and consideration of thermal values prevents damage to the generator.

However, it has been recognized here that additional protection for the generator or specific consideration of the generator torque increases protection against overloading. Particularly, it has been recognized that a loading problem can occur as a result of generator alternating load. High generator alternating load can arise if, during operation above nominal power, an installation has to be suddenly stopped. Provision can then be made to reduce the aerodynamic torque as much as possible such that the generator and therefore the aerodynamic rotor are braked as much as possible, which can result in high loads, e.g., mechanical oscillations, on the installation which are even higher due to the fact that the braking generator torque is above nominal torque.

High generator alternating load can particularly also occur if the generator power has to be abruptly reduced. The generator torque can drop to zero here, as a result of which there is suddenly no more counter torque opposing the aerodynamic torque, which can result in a strong mechanical load on the rotor and then, particularly due to oscillations, in further mechanical loads on the wind power installation.

Therefore, it is particularly proposed to set the maximum generator torque thereof that is to be set, on the basis of operational settings and/or environmental conditions. These can be settings for network support, which, e.g., allow for an accordingly fast response to a network error. As a result, it can be identified whether a fast reduction in power is to be expected. Environmental conditions, such as rain, temperature and storm conditions, allow conclusions to be drawn about whether an installation will likely need to stop in order to prevent a collision with a bird and/or bat.

According to one aspect, it is proposed that, during operation of the wind power installation at a power above the nominal power, the power loss is kept constant, in particular at the value of the power loss limit.

Additionally or alternatively, it is proposed that the power loss limit is determined as power loss dependent on the speed.

This is particularly based on the knowledge and assumption that the monitored flapwise torque continues to remain below the predetermined limit torque. This is thus also monitored and so long as it is the case, the wind power installation can then be controlled or regulated at a constant power loss value. In particular, the wind power installation can be controlled or regulated in such a way that the power loss corresponds to the power loss limit. In other words, the power loss is then adjusted to match the value of the power loss limit.

As a result, a maximum power increase is possible. It has been recognized that, particularly at wind speeds that are only slightly above the nominal wind speed, the flapwise load, that is to say the flapwise torque, can be very high and can be the limiting variable. As wind speeds continue to rise, however, the blades are rotated out of the wind little by little, as a result of which the flapwise torque is reduced and the power loss can then particularly become the limiting variable. The installation can then be adjusted to match the power loss limit.

In particular, it is proposed that the power loss limit is determined as power loss dependent on the speed. At high power, that is to say when the power is increased to above the nominal power, the speed will preferably constantly have the value of the nominal speed. Nevertheless, it is also useful in this case for the power loss limit to be determined on the basis of the speed since, even though the speed is known and predictable in principle, it is still present as a variable in the installation control. The control method can thus consider this speed as an input variable. Since even though the speed may be known, it has a great influence on the power loss and also even on the installation load such that it can form an important variable for determining the power loss limit. Additionally, it may still be the case that the speed, even at the proposed power increase, does not necessarily or always have the nominal speed.

Particularly, the power loss limit can be determined on the basis of a plurality of variables, in particular on the basis of the cooling power and the speed at the same time. If, in this case, the speed constantly has the value of the nominal speed, the power loss limit can nevertheless vary, namely due to variations in the cooling power.

Additionally or alternatively, it is proposed that the power loss limit is determined on the basis of at least one of the variables of wind speed, outside temperature, speed, air pressure and air density, and additionally or alternatively the power loss limit is specified on the basis of an aging characteristic of the wind power installation, in particular in the form of a power loss profile, and/or on the basis of a residual dielectric strength.

Determining the power loss limit on the basis of the wind speed is based on the knowledge that the wind speed itself results in different cooling effects. At the same outside temperature but stronger wind, greater cooling takes place than at the same outside temperature and lesser wind. Correspondingly, the power loss limit can be chosen to be higher at higher wind speed since the wind itself then dissipates more power loss.

Likewise, a lower outside temperature can allow a higher power loss limit because, in this case too, a greater power loss dissipation can be achieved by the low outside temperature.

Likewise, air pressure and/or air density can influence the cooling and therefore make a changed power loss limit appropriate.

Preferably, an aging characteristic of the wind power installation is determined, that is to say it is always taken into consideration how severe the aging of the wind power installation currently is in each case. The aging characteristic can be identified and tracked due to the fact that variables that exert a load on the wind power installation are recorded and correspondingly considered. These may include special situations which exert a load and which are correspondingly recorded, such as, e.g., a storm or an installation emergency stop, or an exceptional gust. The aging is consequently faster or it is slowed when such situations do not occur or occur less than expected.

However, normal installation operation influences the aging too and can be taken into consideration. This particularly includes how often and/or for how long the wind power installation has been operating at which wind speeds. Turbulence intensity of the wind can also be considered and can influence the aging.

As a result, it is also possible, at a current point in time, to evaluate whether the aging of the wind power installation has progressed faster or slower than it should have done as planned at that moment. If the aging has progressed less severely, the power can be raised, possibly higher above the nominal power, and this can be taken into consideration in that the power loss limit changes, that is to say is increased in the mentioned example. If the aging has progressed more severely than it should have done at the current point in time, the power loss limit can be reduced in order to correspondingly preserve the wind power installation to a greater extent.

According to one aspect, it is proposed that, for operating the wind power installation in a transition range for wind speeds from a lower transition wind speed below the nominal wind speed to an upper transition wind speed above the nominal wind speed, a transition operating characteristic curve is specified, the transition operating characteristic curve specifying a blade angle as a function of a measured power, the blade angle increasing as the measured power increases, and the wind power installation being operated using the transition operating characteristic curve until the measured power reaches a switching power value which corresponds to a sum of nominal power and boost power.

The lower transition wind speed can be in the range from 80% to 90% of the nominal speed, in particular can be 80% or 90%. The upper transition wind speed can be in the range from 110% to 120% of the nominal speed, in particular can be 110% or 120%. This is set for the purpose of controlling the blade angle as a function of the measured power. The power can result from a speed-power characteristic curve in which the power is set as a function of the measured speed.

Depending on the wind speed, a speed is thus set at which a power is set which in turn influences the speed. A stable and therefore steady-state operating point can be found here. In addition, but only upward of a wind speed close to the nominal wind speed, the blade angle is adjusted in order to namely reduce the mechanical load on the installation, in particular in order to reduce the flapwise torque. It has been particularly recognized here that, already at wind speeds below the nominal wind speed, a reduction in the mechanical load may be useful. The measured power, that is to say the measured generated power, is in this case a good indicator of how high the load is and is a good variable to be taken into consideration in operational management.

The proposed operation using the transition operating characteristic curve is in this case carried out up to a power above the nominal power. The installation then already has the blades rotated a little bit out of the wind and as a result can absorb more mechanical load. As a result, operation at a higher power than nominal power is also favored.

It is particularly proposed that, if the measured power reaches the switching power value, the power is not increased any further and the blade angle is set by the speed regulator which regulates the speed by adjusting the blade angle. As a result, the operational management can pass seamlessly from using the transition operating characteristic curve to using the speed regulator.

It is preferably proposed to consider the boost power, the prevailing power loss and/or the predetermined power loss limit as a loading criterion.

Based on that, it is particularly proposed that the transition operating characteristic curve be set on the basis of the loading criterion and/or be chosen from a plurality of default operating characteristic curves.

It has been recognized here that, even at the same average wind speed, different loads may be present, as described above and below. Particularly, the consideration of the boost power takes into consideration not only different loads but also adapts the transition operating characteristic curve to match the following operation using the speed regulator. In essence, the speed regulator is applied if the maximum power above the nominal power is reached. This can vary depending on the load on the wind power installation and the speed regulator is therefore then applied at different power levels. The result is a continuous characteristic of a power dependent on the wind speed. In this case, the variation transition operating characteristic curve can ensure that the different power level is achieved by way of different blade angles.

Preferably, an increase in the speed to above nominal speed is permitted in the transition range. As a result, a higher power can be reached without excessive torque. It has also turned out, and is respectively taken into consideration here, that the load as a whole can be less at higher speed.

Further preferably, in the transition range, in addition to the transition operating characteristic curve, use is made of a speed-power characteristic curve which sets a power as a function of a measured speed. As a result, the wind power installation can be operated well in conjunction with the transition operating characteristic curve, as described above.

Preferably, the speed-power characteristic curve is set on the basis of the loading criterion and/or is chosen from a plurality of default speed-power characteristic curves, and optionally the transition operating characteristic curve is set on the basis of the chosen speed-power characteristic curve and/or is chosen from a plurality of default operating characteristic curves. Both characteristic curves can thus be matched well to one another.

According to one aspect, it is proposed that the power loss limit, the boost power and/or operational settings for operating the wind power installation at a power above the nominal power are/is determined on the basis of a stator temperature of a stator of the generator. In particular, this is proposed additionally on the basis of a predetermined reference stator temperature and a specific thermal coefficient of the generator, in particular of the stator. Additionally or alternatively, it is proposed to determine the power loss limit, the boost power and/or operational settings on the basis of the magnetic saturation of the generator.

It has been particularly recognized here that the state of the stator can be a limiting variable for boosting the power above the nominal power. This can be taken into consideration due to the fact that the power loss limit and/or the boost power is determined on the basis of the stator, namely on the basis of a stator temperature and/or a magnetic saturation of the generator.

It has been additionally recognized here that particularly the stator temperature should be limited since it also has an influence on the air gap between the rotor and stator of the generator. If the stator temperature is thus increasing too sharply or if it is absolutely too high, the boost power should accordingly be limited or lowered again, respectively. This can be done by virtue of the boost power accordingly being immediately specified to be lower or being lowered, respectively, or by virtue of the power loss limit being lowered, which then results in the power loss reaching the power loss limit sooner, which likewise results in the boost power being limited or in the boost power being lowered, respectively.

With regard to the magnetic saturation of the generator, it has particularly been recognized that, once this saturation power has been reached, much more power loss is generated in the generator, which is to be avoided since on the one hand it is ineffective and on the other hand can also result in an undesirably high temperature in the generator.

All of this can also be taken into consideration by adapted operational settings such that, for the operational settings too, additionally or alternatively, it is proposed to determine and then set the latter on the basis of the stator temperature and/or on the basis of the magnetic saturation of the generator.

According to one aspect, it is proposed that the prevailing power loss is determined and the operation of the wind power installation at a power above the nominal power is controlled on the basis of the determined prevailing power loss, the prevailing power loss being determined in particular by means of a calculation rule, or being estimated. It has been recognized here that the prevailing power loss can be a good reference variable for controlling the wind power installation when power exceeding the nominal power is being fed in. In this case, it is important that reliable values for the power loss are available and this calculation or estimation is proposed for this purpose.

According to one aspect, it is proposed that the prevailing power loss is determined on the basis of operational parameters which describe states of operation of the wind power installation, additionally or alternatively on the basis of properties of relevant components characterizing the power loss, in particular a temperature of the relevant component in each case, and additionally or alternatively on the basis of environmental parameters which describe conditions in an environment of the wind power installation, in particular wind speed, outside temperature, humidity and/or air pressure.

It has been particularly recognized here that the prevailing power loss can be determined very well and can then be readily reused if suitable parameters or other variables are considered. A prevailing power loss can be determined particularly from operational parameters which describe states of operation of the wind power installation. Such operational parameters can particularly be the prevailing speed, power and set blade angle. Particularly, a generator power output by the generator and an installation power output by the installation can be simultaneously used as operational parameters which describe states of operation of the wind power installation. A power loss can be determined particularly from the difference between the generator power and installation power.

The properties of relevant components characterizing the power loss can be considered additionally or alone. The temperature of relevant components comes into particular consideration here. Relevant components are in particular regarded to be those components which respectively make up over 10% of the power loss. In particular, such relevant components are the generator, rectifier and inverter. The connecting line, particularly the cable between the rectifier and inverter, can be added if the rectifier and inverter are locally separated, namely the rectifier is arranged in the nacelle near the generator and the inverter is arranged at the foot of the tower. Obviously, the higher the temperature of such relevant components, the higher the power loss. This can be evaluated not only qualitatively but also quantitatively.

Environmental parameters, such as wind speed, outside temperature, humidity and/or air pressure, can be evaluated in particular in addition. Boundary conditions which influence the power loss can be derived from these environmental parameters. As a result, the calculations based on operational parameters and/or properties of relevant components can be improved. However, it also comes into consideration to infer the power loss from such environmental parameters alone. This particularly comes into consideration if a good simulation for the wind power installation is available or can be made. Ultimately, the operation of the wind power installation depends almost solely on such environmental parameters. From the environmental parameters, in particular wind speed, it is possible to determine how the wind power installation would behave, including its power loss, the power loss possibly being additionally influenced by outside temperature since the lower it is, the better said wind power installation can be cooled and vice versa. Humidity and air pressure can be added in addition; these particularly influence the operation of the wind power installation. The same wind speed at different humidity and/or different air pressure results in different operation of the wind power installation. All of this could be considered in a simulation and if said simulation considers the installation behavior, including the proposed power boost, the power loss can be determined therefrom.

Preferably, however, operational parameters, properties of relevant components and environmental parameters are considered together in order to determine the power loss.

The power loss is thus available with good accuracy and the power boost can be controlled or regulated on the basis of this power loss such that as much of a power boost as possible is possible without however setting an excessive power loss, that is to say without compromising the installation.

An exemplary calculation formula for the maximum power loss is mentioned further below and is applicable here too. The prevailing power loss is measured.

According to one aspect, it is proposed that the prevailing power loss and/or a component temperature are/is determined on the basis of an air gap thickness of the generator. It has been particularly recognized here that the power loss influences the temperature of the generator. Other temperatures, that is to say component temperatures of other components, likewise arise from the power loss. Although the power loss of the generator does not influence the temperature of other components directly, if the generator experiences for example an increase in temperature on account of an operational situation and on the basis of environmental parameters, an increase in temperature in other components can thus also be expected. It is therefore possible to draw conclusions about the temperature of other components from the generator. As one possibility, however, the component temperature includes the temperature of the generator too.

The prevailing power loss and/or a component temperature, that is to say including the temperature of the generator, can therefore be determined from the behavior of the generator. It has been particularly recognized here that the armature and stator of a generator expand to differing degrees dependent on temperature. On the one hand, this is because the stator and/or generator are cooled to differing degrees and/or dissipate heat to differing degrees. On the other hand, this is because a different expansion can occur even at the same temperature.

This consequently results in different air gap thicknesses dependent on temperature. If the generator is in the form of an internal armature, an increase in temperature can result in the stator being cooled better, therefore expanding to a lesser degree and the armature therefore expanding to a greater degree, as a result of which the air gap thickness decreases as temperature increases. The respective effects are to be considered individually for each generator type and installation type, particularly in quantitative terms.

In any case, the prevailing power loss and/or at least one component temperature can thus be determined in a simple way namely due to the fact that the air gap thickness of the generator only has to be determined at one point.

According to one aspect, it is proposed that, for determining the prevailing power loss limit, operational parameters of a plurality of components of the wind power installation are considered, and in particular the power loss limit is determined in such a way that the considered operational parameters do not exceed predetermined parameters limits. Such operational parameters can particularly be temperatures but also a magnetization, a generated electromagnetic force or a vibration amplitude. Such operational parameters are considered and the prevailing power loss limit is correspondingly determined, namely such that the considered operational parameters do not exceed predetermined parameter limits.

It also comes into consideration for this to be implemented by regulation in that the operational parameters are considered and, if they are too large, in particular if at least one of these operational parameters is too large, the power loss limit is reduced. If all of the operational parameters are lower than a respectively permissible limit, the power loss limit can be increased.

In particular, it is proposed that one operational parameter, a plurality or all of the operational parameters from the following list are considered, which list comprises the following operational parameters:
a generator temperature;
a temperature of an infeed unit;
a temperature of an electrical line, in particular a line between the generator and the infeed unit for transmitting electrical power from the generator to the infeed unit;
a temperature of an electrical inductor;
a temperature of a secondary circuit of an active cooling system;
a magnetization of the generator, a magnetic saturation being used as the predetermined parameter limit;
an electromagnetic force generated in the generator; and
a vibration amplitude of a mechanical vibration caused by the operation of the wind power installation.

A generator temperature should not be too high and a temperature limit can be at 155° C. This can be a temperature limit for the generator temperature but also for other elements, in particular the temperature of an electrical line and the temperature of an electrical inductor. This temperature may be related to the permissible temperature of an electrical insulation.

This temperature limit can likewise apply for the temperature of an infeed unit; however, with the temperature of an infeed unit, a measurable temperature may have a lower limit since an infeed unit generates high temperatures in the interior of the component, particularly in its semiconductor switches in internal boundary layers due to the switching processes. The outside temperature of such a semiconductor component should therefore be kept below a limit which at the same time prevents an excessive temperature in the interior of the semiconductor component. The power loss limit can be lowered here too if such a temperature of an infeed unit becomes too high.

A temperature of an electrical line, in particular a line between the generator and infeed unit for transmitting electrical power from the generator to the infeed unit, should also at least adhere to a maximum temperature specified by the electrical insulation, as explained above. When it comes to the electrical line, it should also be considered that this line often has to withstand a high tensile load due to its own weight when it hangs in the tower. The connection of the electrical line from the generator to the infeed unit can also mean the connection from an active rectifier, which is arranged adjacent to the generator, to the inverter, which may be arranged at the foot of the tower.

An electrical inductor can likewise be a relevant component and, just like the aforementioned elements, its temperature also greatly depends on the power since this power is routed through the electrical inductor for infeeding. In the case of the electrical inductor, too, the electrical insulation can limit a maximum temperature.

A temperature of a secondary circuit of an active cooling system provides information about the temperature in the component that is being cooled. It comes in particular into consideration here that a primary cooling circuit uses a first cooling medium to cool a component that is to be cooled and this first cooling medium transfers heat via a heat exchanger to a second cooling medium in the secondary circuit. From simulations or previously conducted tests, it is then possible to draw conclusions from the lower temperature of the secondary circuit about the higher temperature of the component that is to be cooled.

A magnetization of the generator arises particularly in the stator due to the stator current. Such a magnetization can be measured if sensors are arranged in the generator for this purpose. However, this is frequently not the case and this magnetization can then or additionally be inferred from the knowledge of the generator, that is to say its design and its materials, from the operating state of the generator, in particular its speed, and from the stator current.

It has been particularly recognized here that operating the generator at magnetic saturation should be avoided. Magnetic saturation is a material property and consequently determinable in advance or known for each generator at least during the development of each generator and should be taken into consideration here for controlling or regulating the power boost.

An electromagnetic force generated in the generator should likewise not be too large in order to keep mechanical damage or at least loads within limits. The electromagnetic force generated in the generator can also be derived from the knowledge of the generator, its operating state, that is to say in particular the speed, and from the stator current. It should be considered that the magnetization is in no way proportional to the generated electromagnetic force and it is therefore proposed to take these two operational parameters into consideration separately. The magnetic force may also depend on the air gap thickness and so it is proposed to take this air gap thickness into consideration when the magnetic force is being taken into consideration.

Although a vibration amplitude of a mechanical vibration caused by the operation of the wind power installation also depends on the frequency of its excitation and therefore on the speed of the generator, the amplitude can also be influenced by a temperature. For example, a change in temperature can marginally change the expansion of a mechanical component, which can result in a change in friction if for example a corresponding bearing is affected by this thermal expansion, as a result of which vibrations can be amplified or possibly only even occur then. A vibration amplitude may also be related to a magnetic force. If an electromagnetic force between the electromagnetic rotor, that is to say an armature, and the stator is too great, the rotation of the armature can result in a vibration.

All this has been recognized and it is therefore proposed to take a vibration amplitude into consideration. If said vibration amplitude is too great or threatens to become too great, it is proposed to reduce the power loss limit.

According to one aspect, it is proposed that the boost power, the prevailing power loss and/or the power loss limit, and/or the limit torque for the flapwise torque, are/is determined on the basis of one, a plurality or all of the following criteria which can be referred to as determination criteria.

One determination criterion is a site of the wind power installation. Such a site can be particularly characterized by environmental parameters, such as air pressure, average temperature and average turbulence intensity. The air pressure depends in particular on the height of the installation site. The average temperature depends, among other things, on geographic latitude. The site of the wind power installation can particularly influence whether the wind power installation is comparatively strongly or weakly loaded and the boost power, which likewise constitutes a load for the wind power installation, can be more or less large accordingly.

One determination criterion can be the wind direction. The wind direction can be considered in conjunction with the installation site and provide information about whether wind that is more or less strong is likely because more turbulent wind can be expected from some wind directions due to obstacles. Humidity and/or temperature may also depend on the wind direction, possibly also on time of day and/or time of year.

The time of day and/or time of year can also be a determination criterion independently of the wind direction, that is to say more generally. A higher load can thus be expected in summer than in winter because higher temperatures are to be expected in summer which can be more critical for operation at elevated power. However, it also comes into consideration that at particularly cold installation sites in winter the temperature is so low that the material is so brittle that this does not allow for an excessive elevation in power, if any at all.

A turbulence intensity is a further determination criterion and it likewise influences the mechanical load on the wind power installation, in particular on the rotor blades. Preferably, provision can be made to reduce the limit torque at high turbulence intensity in order to thus allow only a smaller flapwise torque.

It should be considered that a maximum flapwise torque is a property of the wind power installation on the basis of which the wind power installation is designed, among other things. However, the limit torque is specified in such a way that a tolerance is also additionally adhered to in order that variations in the flapwise torque, particularly due to changes in the wind, particularly due to gusts, do not result in an excessive increase. Depending on the situation, particularly depending on the wind situation, that is to say whether the wind has a high or low gustiness and/or has large or small changes in direction, a larger or smaller tolerance may suffice, however, and so different values for the limit torque can be used.

Wind shear is a further determination criterion. Wind shear reveals that the wind field is not homogeneous, rather different wind speeds occur at different points, in particular at different heights, and consequently this can particularly result in unsymmetrical loads on the blades and/or on the rotor. Accordingly, wind shear also influences the load on the wind power installation as a whole and in the event of strong wind shear provision can be made to choose a smaller boost power than in the event of weak wind shear.

One determination criterion can be the environmental temperature. The environmental temperature has already been mentioned above; it can particularly have an influence on the cooling of the wind power installation and the power loss can consequently be dissipated better and the temperature in the wind power installation can be kept lower. A larger boost power would then be possible.

The air pressure is a further determination criterion and different air pressures can result in different loads on the rotor blades and so consideration is proposed here.

The humidity can likewise be a determination criterion. Humidity likewise influences the force that the wind can exert on a rotor blade at the same wind speed. Simply put, humid air is heavier and can therefore result in stronger forces.

According to one aspect, it is proposed that, for operating the wind power installation at a power above the nominal power, operational settings, in particular the blade angle, are set on the basis of the prevailing wind speed and on the basis of the boost power, the prevailing power loss and/or the power loss limit, and/or the operational settings are determined by a calculation rule.

It is therefore proposed to expressly consider the wind speed in order to set the operational settings, in particular the blade angle. In addition, the boost power, the prevailing power loss and/or the power loss limit are/is considered. Provision is therefore made for a controller which chooses or changes the operational settings on the basis of these values, in particular which determines the blade angle on the basis of these variables. The blade angle is thus set on the basis of the prevailing wind speed and in addition on the basis of the boost power, the prevailing power loss and/or power loss limit. An operating point can therefore be directly specified and set. This prevents oscillations from occurring due to regulation. Mechanical overloading of the structure is also reduced.

According to one aspect, it is proposed that, for operating the wind power installation in a storm mode when the wind speed is above a predeterminable storm wind speed, a storm characteristic curve which specifies a correlation between speed and power is provided; for controlling the wind power installation in a transition from full-load operation to storm mode when the wind power installation is operated in full-load operation at a power above the nominal power, a transition storm characteristic curve which specifies a correlation between speed and power, said correlation differing from the correlation according to the storm characteristic curve, is provided, in particular the transition characteristic curve assigning higher power values to the same speed values in each case as compared to the storm characteristic curve.

The storm characteristic curve and also the transition characteristic curve can be regarded as operating characteristic curves. They assign a power value to a speed in each case. In particular, provision can be made for this storm characteristic curve or transition characteristic curve, respectively, to be implemented in such a way that a speed is measured and a power is set on the basis thereof. In particular, provision can be made in this case for the wind speed to be measured and for the speed to be set on the basis of the wind speed initially by adjusting the rotor blades, and then for the power to be additionally set; or for speed and power to be specified according to the characteristic curve as a function of the wind speed, whereby the power is set, in particular by corresponding actuation of the generator, and the rotor blades are set in such a way that the desired speed then arises.

In any case, both the storm characteristic curve and the transition characteristic curve assign speed values to power values in each case. The characteristic curve can thus be illustrated by a multiplicity of speed-power pairs. In this case, provision is made for the transition characteristic curve to differ from the storm characteristic curve. In this case, the transition characteristic curve is provided for the case in which the wind power installation is operated in full-load operation at a power above the nominal power. Particularly, here, there is an operating point at which the wind speed is already quite high, practically just before the storm wind speed.

It has been particularly recognized here that the storm characteristic curve is provided, upward of the storm wind speed, to reduce the power to below the nominal power and to reduce the speed to below the nominal speed. This is based on the idea that, practically at the transition point, if storm wind speed is present, the power needs to be reduced to below nominal power as the wind speed continues to increase, in order to protect the installation. At storm wind speed, the nominal power is therefore the maximum permissible power. It has therefore been recognized that when the wind power installation is operated in full-load operation at a power above the nominal power, at storm wind speed, this results in an operating point which differs from the operating point, that is to say from the combination of speed and power, according to the storm characteristic curve. The storm characteristic curve gives nominal power namely for the storm wind speed at which namely the storm characteristic curve begins.

It is proposed here, at the time of the storm wind speed, not to perform any rapid changes from the increased power to the nominal power according to the storm characteristic curve but rather to provide a transition characteristic curve instead. At wind speeds above the storm wind speed, this transition characteristic curve can pass over into the storm characteristic curve; however, the storm characteristic curve and the transition characteristic curve preferably differ beyond the storm wind speed, in particular even over the entire storm range. The transition characteristic curve thus then specifies a correlation between speed and power for part of or the entire storm range, independently of and differently to the storm characteristic curve.

In addition to the aspect of avoiding the mentioned jump, this is also based on the knowledge that, even in the event of a storm, a higher power can still be requested than is provided for with the storm characteristic curve. Here, in addition to operation using the transition characteristic curve, the load on the installation can be monitored too. Particularly, during operation using the transition characteristic curve, it is possible to check that flapwise loads and the power loss are not too large, it probably not being possible for the power loss to become too large on its own since the power is reduced anyway. However, while monitoring this load, should it turn out that the provided speed and/or power according to the transition characteristic curve are/is too large, provision can be made to adapt the transition characteristic curve.

Also proposed is a wind power installation which is designed as explained above and has a control device for controlling the wind power installation. Additionally, the wind power installation is set up to perform a method for controlling a wind power installation according to at least one of the embodiments described above. In particular, the control device is set up to perform such methods.

The control device can be in the form of a process computer and be coupled to the corresponding elements of the wind power installation. Additionally, coupling to an external weather forecast and/or to external sensors for measuring environmental parameters can be provided.

The method can in particular be implemented on such a process computer, in particular by a program code which performs the corresponding method steps when it is executed on a computer.

As a result, it is possible to propose a wind power installation which can achieve an increased yield while simultaneously avoiding unnecessary overloads.

### BRIEF DESCRIPTION OF THE SEVERAL VIEWS OF THE DRAWINGS

The invention will now be described below by way of example on the basis of exemplary embodiments with reference to the accompanying figures.

FIG. 1 shows a perspective illustration of a wind power installation.

FIG. 2 shows a power-/flapwise torque-wind speed graph for the previous behavior of a wind power installation.

FIG. 3 shows a power-wind speed graph.

FIG. 4 shows a blade angle-wind speed graph.

FIG. 5 shows a flapwise torque-wind speed graph.

FIG. 6 schematically shows a regulating structure.

### DETAILED DESCRIPTION

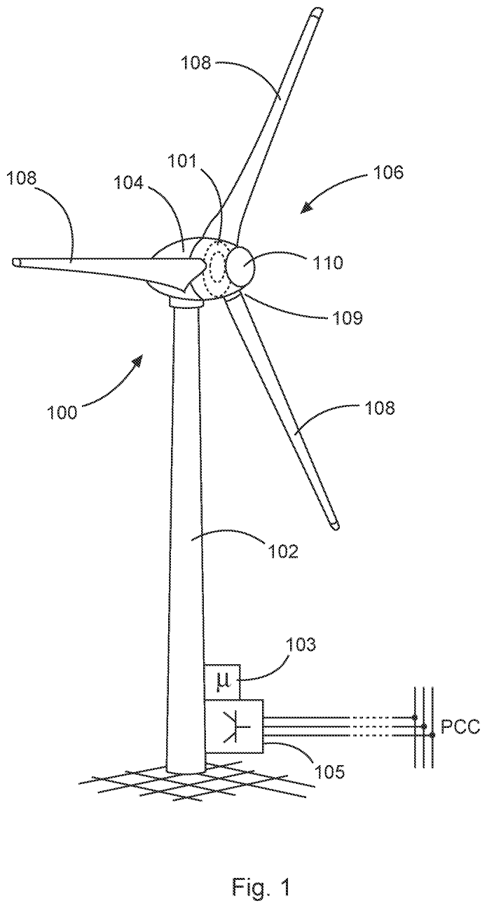

FIG. 1 shows a schematic illustration of a wind power installation. The wind power installation 100 has a tower 102 and a nacelle 104 on the tower 102. An aerodynamic rotor 106 having three rotor blades 108 and a spinner 110 is provided on the nacelle 104. During the operation of the wind power installation, the aerodynamic rotor 106 is set in rotational motion by the wind and thereby also rotates an electrodynamic rotor or armature of a generator, which is coupled directly or indirectly to the aerodynamic rotor 106. The electric generator is arranged in the nacelle 104 and produces electrical energy. The pitch angles of the rotor blades 108 may be varied by pitch motors at the rotor blade roots 109 of the respective rotor blades 108.

The wind power installation 100 in this case has an electric generator 101, which is indicated in the nacelle 104. Electric power is able to be generated by way of the generator 101. Provision is made for an infeed unit 105, which may be designed in particular as an inverter, to feed in electric power. It is thus possible to generate a three-phase infeed current and/or a three-phase infeed voltage in terms of amplitude, frequency and phase, for infeed at a grid connection point PCC. This may be performed directly or else together with other wind power installations on a wind farm. Provision is made for an installation control system 103 for the purpose of controlling the wind power installation 100 and also the infeed unit 105. The installation control system 103 may also receive predefined values from an external source, in particular from a central farm computer.

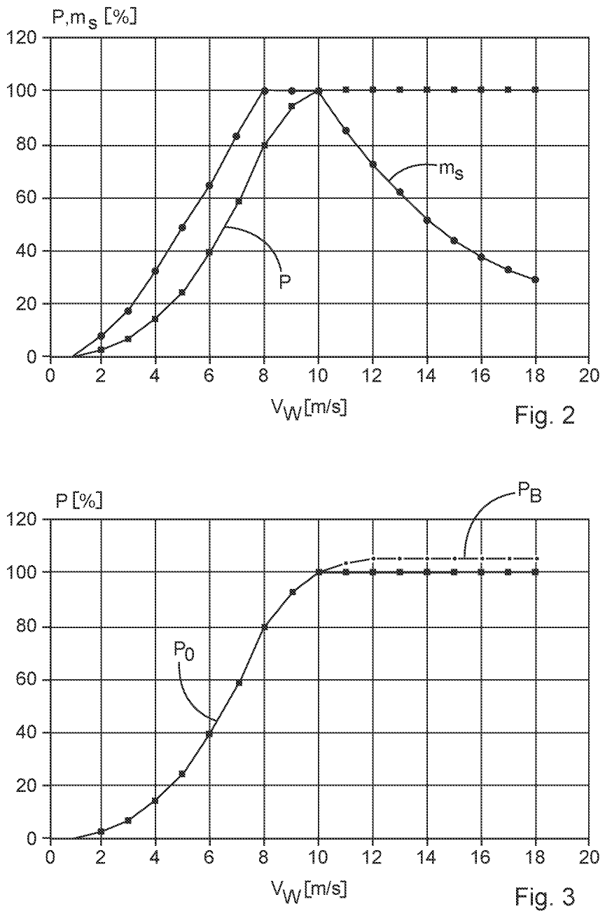

FIG. 2 shows a graph in which the power P and the flapwise torque ms are each illustrated as a curve as a function of the wind speed. The wind speed is thus plotted in m/s on the x-axis and the power and also the flapwise torque, each standardized to nominal values, are plotted on the y-axis.

The graph assumes a nominal wind speed of approximately 10 m/s. Until then there is a part-load range or until then the wind power installation is operated in part-load operation. The wind speed P reaches its maximum value, namely nominal power and thus 100%, at nominal wind speed. Upward of nominal wind speed, the power is kept at nominal power.

The flapwise torque likewise rises in the part-load range as the wind speed increases but reaches its maximum value, that is to say 100%, earlier, namely at 8 m/s wind speed in the example shown. As a result, the certified loads are not exceeded. The increasing load due to the wind as wind speed continues to rise is compensated for by adjusting the rotor blades so that the flapwise torque initially remains at its maximum value of 100%.

At nominal wind speed of 10 m/s in the example, the rotor blades are adjusted more in order to also keep the power at its nominal value, that is to say at 100%. The result of this is that, upward of nominal wind speed, the flapwise torque decreases as wind speed continues to rise.

It has been recognized that this decrease in the flapwise torque, upward of nominal wind speed as wind speed continues to rise, opens up the possibility of nevertheless raising the power to above nominal power. At least this mechanical load of the flapwise torques allows this. In this case, it has been particularly recognized that the flapwise torque decreases quite sharply. The intention is to make use of this possibility for boosting the power but while taking into consideration other limiting criteria.

FIG. 3 shows a power curve as a function of the wind speed, with the normal power P₀ and the boosted power P_{B} being illustrated. Both power curves run identically up until the nominal wind speed at the exemplary 10 m/s. Upward thereof, the boosted power can then assume greater values such that the boosted power P_{B} rises a little more upward of nominal wind speed. However, it soon reaches a plateau, which is particularly explained by the fact that other limitations need to be observed, particularly electrical and/or thermal limitations related to the power.

Nonetheless, FIG. 3 illustrates that it is possible to achieve power boosts of 5% and more. FIG. 3 additionally illustrates that the power boost is possible not only for a small range but can come into consideration for the entire full-load range. And in this respect, the graph in FIG. 3 and thus also the range of the boosted power extend approximately to the end of the full-load range, which is followed by a storm range which is not illustrated in this graph, however.

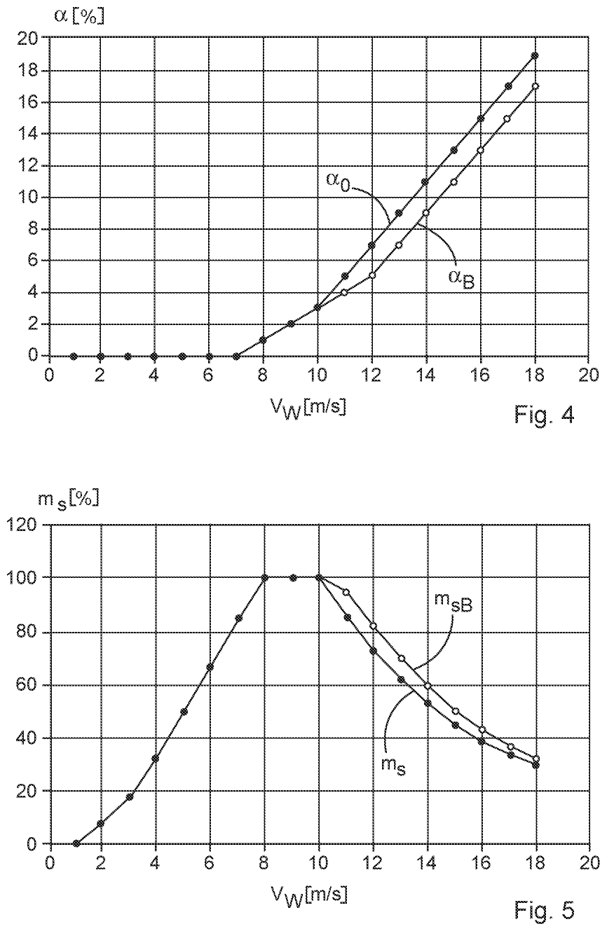

FIG. 4 shows the curve of a blade angle as a function of the wind speed, with a normal blade angle curve α₀ and a blade angle curve α_{B} for a boosted power being illustrated. It can be seen that both blade angle curves run identically up until the nominal wind speed of the exemplary 10 m/s.

Upward of the nominal wind speed, the blade angle according to the blade angle α_{B} for the boosted power is initially increased to a lesser degree than the normal blade angle curve α₀. Upward of a certain wind speed, which is 12 m/s in the example, both blade angle curves then run parallel to one another, however. They run parallel to one another upward of the wind speed from which the boosted power has also reached a plateau and therefore the boosted power runs parallel to the non-boosted power, that is to say parallel to the value of the nominal power.

In both cases, the rotor blades are thus rotated further out of the wind as wind speed increases such that load is accordingly also reduced. For the blade angle α_{B} for the boosted power, the blade angle values are a little smaller, however, and so the blades are thus each rotated a little less out of the wind than in the case of the normal blade curve α₀.

FIG. 5 shows a graph which illustrates the flapwise torque as a function of the wind speed. Here, too, the normal curve is contrasted with the curve for boosted power. The normal curve thus shows the blade flapwise torque ms and the curve for the boosted power shows the flapwise torque m_{SB}.

The curve of the normal flapwise torque ms thus also corresponds to the curve of the flapwise torque according to FIG. 2.

The flapwise torque m_{SB} according to boosted power, upward of nominal wind speed, likewise decreases as wind speed increases, but not so sharply. Nonetheless, it decreases considerably such that the power boost, which underlies the flapwise torque m_{SB}, does not constitute a load problem for the flapwise torque.

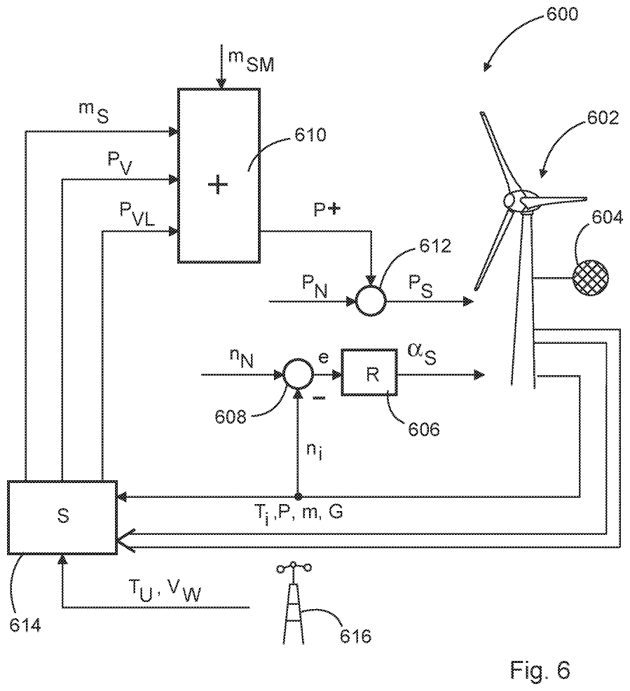

FIG. 6 schematically shows a regulating structure (e.g., controller) 600 having a schematically indicated wind power installation 602 which feeds into an electrical supply network 604 which is likewise only schematically indicated.

The structure illustrates that the wind power installation 602 is basically controlled by virtue of it receiving a power setpoint value P_{S} and a blade angle setpoint value α_{S}. The blade angle is the result of speed regulation using speed regulator (e.g., controller) 606. The speed regulator 606 receives a speed differential which is formed, at the first summing point 608, from the setpoint speed, which is specified as nominal speed n_{N} here, and the actual speed nᵢ. The resulting control error e is then input into the speed regulator 606 and a blade angle α_{S} that is to be set is determined on the basis thereof. A common application can also be configured in such a way that a blade angle adjustment rate is output instead of an absolute blade angle α_{S}. For this purpose, the blade angle α_{S} should also be representative.

In order to control the power boost, it is preferably proposed that the speed is not increased and only the power is increased. The speed regulator shown can therefore continue to operate as normal in the event of the power being increased beyond the nominal power. However, other values for the blade angle will arise because increasing the power, which will be explained shortly, brakes the speed and so the blade angles have to be adjusted to a lesser degree in order to obtain the same speed.

The power is basically controlled in such a way that a desired power is specified as the power P_{S}, that is to say the setpoint power. This power specification can be specified during operational management, which is not illustrated in FIG. 6 for the sake of simplicity. In full-load operation, still before the storm mode, nominal power P_{N} is specified as the setpoint power, however. In this case, the setpoint power P_{S} corresponds to the nominal power P_{N} if no power boost is proposed.

In order to boost the power, the power boost block 610 is provided. The power boost block 610 thus calculates a possible boost power P⁺ which is added to the specified power, that is to say the nominal power P_{N} here, at the second summing point 612. Consequently, a larger value than the nominal power P_{N} can result for the setpoint power P_{S}.

In order to calculate this boost power P⁺, a maximum flapwise torque m_{SM}, which thus forms a limit torque for the flapwise torque, is taken into consideration. This value is symbolically input into the power boost block 610 in FIG. 6. Since this value may be a fixed value, it may also be implemented in a fixed manner, which should be included with this symbolic illustration of the input of the maximum flapwise torque m_{SM}.

Additionally, a predeterminable power loss limit P_{VL} is taken into consideration. This power loss limit, which specifies a maximum value for the power loss, may be variable and its calculation is explained further below.

In order to take into consideration these two maximum values, that is to say the maximum flapwise torque m_{SM} and the power loss limit P_{VL}, the corresponding measurement values or measured values are observed and likewise input into the power boost block 610. Therefore, the prevailing flapwise torque ms and the prevailing power loss P_{V} are thus input there into the power boost block 610.

The power boost block 610 correspondingly takes this into consideration, namely such that the prevailing flapwise torque ms does not exceed the maximum flapwise torque m_{SM}. Additionally, the boost power P⁺ is specified in such a way that the prevailing power loss P_{V} does not exceed the power loss limit P_{VL}.

In order to determine the prevailing flapwise torque ms and the prevailing power loss P_{V}, a determination block 614 is provided. This determination block 614 can receive many values which have been measured at the wind power installation. These values may include various component temperatures, for which the temperature Tᵢ symbolically and representatively stands here. Additionally, the determination block 614 can receive the prevailing power P, the prevailing torque of the generator m and various other variables of the generator, for which a generator variable G is symbolically specified. Yet further values can also be received, such as operating states of auxiliary devices such as, e.g., a fan of a cooling system, or a circulating pump of a cooling circuit comprising liquid medium.

All these variables, and in particular additionally the measured speed nᵢ, are input into this determination block 614.

The determination block 614 can additionally receive environmental parameters, such as an outside temperature T_{U} or a wind speed V_{W}, from a measuring mast 616. However, such and other environmental parameters can also be determined by the wind power installation by means of sensors arranged on the nacelle, for example.

The determination block 614 can particularly determine the prevailing values of the blade flapwise torque ms and of the power loss P_{V}. For this purpose, an estimation algorithm can be provided in each case, or use can be made of a regulation-oriented estimator, such as, e.g., a state observer.

Additionally, the power loss limit P_{VL} is determined in the determination block. This power loss limit may also depend on many of these measurement values from the wind power installation 602.

The determination block 614 thus determines the prevailing blade flapwise torque ms, the prevailing power loss P_{V} and a maximum power loss P_{VL} which forms the power loss limit. In another configuration, if the maximum blade flapwise torque ms is likewise intended to be set in a variable manner, in particular on the basis of situations or states of the wind power installation, this could also be determined by the determination block 614.

The following has additionally been recognized or the following is proposed.

It has been recognized that the limiting factors for the maximum possible power in a wind power installation, which can also be abbreviated as WPI, can be summarized in the following three categories:

Category 1—Loads: Particularly the maximum flapwise load and the maximum torque define the loads. They are limited by the certified loads.

Category 2—Network restrictions: The electrical supply network may specify a maximum power that is to be fed in. This is commonly defined in advance and particularly also depends on the network connection point.

Category 3—Operational parameters: Operational parameters of all components of the wind power installation may necessitate limitations. In particular, speed, magnetic saturation and temperatures of different components, to name just some examples, may be limiting operational parameters.

In order to increase the power, particularly also independently of the duration outside of the nominal range, the limits in all three above-mentioned categories must not be violated.

FIG. 2 therefore shows the curve of the blade flapwise torque and of the power against the wind speed for a possible wind power installation according to a simulation. It can thus be seen therefrom that the flapwise torque ms, which is therefore a load, already reaches its maximum value before reaching the nominal wind speed, here 10 m/s, and subsequently decreases due to the pitch control which may result from the speed regulation. In this application, the range above the nominal wind speed of 10 m/s is looked at in particular. The certified loads are therefore not exceeded.

If it turns out, in the wind speed range above the nominal wind speed at which the wind power installation reaches its nominal power, that a greater torque than the design torque of the rotor and therefore also a higher power than the nominal power of the generator is desired under certain circumstances, this can be generated by adapting the pitch regulation in a targeted manner, which FIG. 2 is likewise intended to illustrate.

For this purpose, the pitch parameters are changed in such a way that, in the range above the nominal wind speed, larger operating angles of attack are driven on the rotor blades, which leads to the result according to FIG. 3. As a result, for the same speed, the boost and therefore the torque of the rotor are increased. In this case, however, the angles of attack are only increased to the extent that it is ensured that the maximum permissible blade flapwise loads are not exceeded, which FIG. 4 is intended to illustrate. During this procedure, in contrast to the standard design, the rotor speed usually remains unchanged.

The pitch parameters can also be adapted gradually depending on the required torque and required power. The pitch parameters can denote the respectively set blade angles and they can be set by a speed regulator.

In order to increase the maximum permissible power, which is to be fed in, to above the nominal power of the wind power installation, provision can be made to coordinate this increase with network operators or other authorities.

It is particularly proposed to develop operational management which does not exceed the permissible operational parameters for all relevant components while meeting the conditions of categories 1 and 2 (loads and network restrictions). This application defines various methods for boosting the power without damaging the wind power installation components.

Various methods or partial approaches for defining the possible control parameters are proposed.

The following methods consider component efficiency or electrical losses.

The electrical losses of a wind power installation component, e.g., of the stator of a generator, can be ascertained by measurement. A predefined maximum allowed power loss can be defined or predetermined on the basis of wind speed, rotation speed, that is to say rotor speed, atmospheric pressure and atmospheric density. This information may already be included in operational management for normal values of pressure and density and can be expanded for other values of pressure and density if necessary.

In the following method, regulation is used.

The real power loss can be ascertained using the following formula:

$$\\ Pv , ax = ( ( ( ( ( {R}_{real} / R 20 ) - 1 ) / f ) + 20 ) - ( p / R \cdot ρ ) ) / α$$

Pv,max: is the maximum allowed power loss of a component, unit [W]
Rᵣₑₐₗ: is the measured electrical resistance of the component, unit [ohm]
R20: is the electrical resistance at 20° C., unit [ohm]
f: is a correction factor, which can be assumed to be 0.004.
p: is atmospheric pressure, unit [Pa]
R: is a gas constant, which is 287 J/kg·K for air
ρ: is the air density [kg/m³]
α: is a slope factor. Can be ascertained for a component by simulation data or measurement data.

Various possibilities for controlling the installation are proposed:

1. The power loss can be kept constant

2. A speed-dependent maximum power loss is determined. The maximum permissible power loss can be ascertained taking into consideration the following formula:

$$\\ {P}_{vr} = ( {T}_{st} - {T}_{ref} ) / {α}_{spez}$$

with the power loss Pᵥᵣ, the maximum stator temperature Tₛₜ, the reference temperature T_{ref}, and the specific thermal coefficient α_{spez}.
Tₛₜ and α_{spez} depend solely on the turbine-type-specific configuration and on the materials used, respectively.

3. A wind-speed-dependent and speed-dependent power loss is determined. This is especially advantageous for components which are, in part or fully, cooled directly by the outside air. Since the generator can tolerate considerably more power loss as wind speed increases.

4. A maximum power loss or a power loss profile is determined using an aging formula, such as, e.g., an Arrhenius formula. The aging formulae can be applied on the basis of input data about the expected temperature distribution in an electrical component, the residual dielectric strength of the insulation after a predefined number of operating hours/years. The dielectric strength of the insulation of an electrical component, in particular of generator and inductor, to name just some examples, decreases over time, particularly at high or higher loading, and must not exceed a certain limit, e.g., 60% of the starting value. The residual dielectric strength can therefore influence or specify the service life of the component in a certain load profile.

The following possibility considers the generator air gap.

One possible solution consists in a temporary power increase being regulated to the air gap between the rotor and stator of the generator. The temporary power increase can also be referred to as a temporary power boost. For this purpose, an optical measurement system can be installed in the generator and continuously determine the size of the air gap, in particular a distance between the rotor and stator.

If it is assumed that the expansion of a body is proportional to the change in temperature, the air gap reduces in linear fashion when the generator heats up

$$\\ \begin{matrix}{L}_{rot} ( T ) = {L}_{rot} ( {T}_{ref} ) \cdot [ 1 + {α}_{rot} ( T - {T}_{ref} ) ] \\ {L}_{stat} ( T ) = {L}_{stat} ( {T}_{ref} ) \cdot [ 1 + {α}_{stat} ( T - {T}_{ref} ) ]\end{matrix}$$

Therein, L is the diameter of the generator, αᵣₒₜ, αₛₜₐₜ are the coefficient of thermal expansion, T is the temperature of the generator. The indicators rot and stat relate to the rotor and stator of the generator. Ref denotes the reference values.

The air gap can therefore be calculated as follows

$$\\ d = {L}_{rot} - {L}_{stat} = {L}_{rot} ( Tref ) - {L}_{stat} ( {T}_{ref} ) + [ {α}_{rot} - {α}_{stat} ] \cdot ( T - {T}_{ref} )$$

It is then possible to ascertain the permissible minimum air gap by way of simulations, calibration measurements or permissible maximum temperatures of the materials. If the measured air gap is undershot during operation of the installation, the limit of the temporary power boost or of the temporary power increase is reached and the generated power must be scaled back. In this case, it is possible to specify a speed-dependent specification for the minimum air gap.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

European patent application no. 22216455.0, filed Dec. 23, 2022, to which this application claims priority, is hereby incorporated herein by reference in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for controlling a wind power installation having an aerodynamic rotor which is operable at variable speed and which has rotor blades which are adjustable in terms of their blade angle, and having a generator for generating a generator power, the wind power installation being distinguished by a nominal speed, a nominal power and a nominal wind speed at which the nominal speed and the nominal power are reached, and the method comprises:
for a wind speed above the nominal wind speed;
operating the wind power installation at a power above the nominal power;
the power being above the nominal power by a boost power;
the wind power installation being operated in such a way that a flapwise torque remains below a predeterminable limit torque; and
a prevailing power loss does not exceed a predeterminable power loss limit.

2. The method as claimed in claim 1, wherein,
provided that the wind speed is sufficiently high,
the wind power installation is continuously operated at a power above the nominal power, in particular over a period of at least 10 minutes, in particular of at least one hour, and/or wherein
the boost power is at least 1%, preferably at least 5%, in particular at least 8%, of the nominal power.

3. The method as claimed in claim 1, wherein,
while the wind power installation is being operated at the power above the nominal power, the speed is regulated to nominal speed.

4. The method as claimed in claim 1, wherein,
during operation of the wind power installation at a power above the nominal power, the power loss limit is determined on the basis of a cooling power, in particular
the cooling power being estimated or being calculated using a calculation rule, and/or
the cooling power for the generator and/or further electrical components, in particular an electrical drive train, being determined, and/or
the wind power installation being operated at a power above the nominal power in such a way, in particular the boost power being chosen in such a way that a generator torque does not exceed a predeterminable generator limit torque, and/or the generator torque being set in such a way that the generator limit torque is not exceeded, and in particular the generator limit torque being set on the basis of operational settings and/or environmental conditions.

5. The method as claimed in claim 1, wherein,
during operation of the wind power installation at a power above the nominal power,
the power loss is kept constant, in particular at the value of the power loss limit, and/or
the power loss limit is determined as power loss dependent on the speed,
the power loss limit being determined on the basis of at least one variable from the list comprising:
wind speed;
outside temperature;
speed;
air pressure;
air density; and/or
the power loss limit being specified on the basis of an aging characteristic of the wind power installation, in particular in the form of a power loss profile, and/or on the basis of a residual dielectric strength.

6. The method as claimed in claim 1, wherein,
for operating the wind power installation in a transition range for wind speeds from a lower transition wind speed below the nominal wind speed to an upper transition wind speed above the nominal wind speed, a transition operating characteristic curve is specified, whereby
the transition operating characteristic curve specifying a blade angle as a function of a measured power,
the blade angle increasing as the measured power increases, and
the wind power installation being operated using the transition operating characteristic curve until the measured power reaches a switching power value which corresponds to a sum of nominal power and boost power, in particular,
if the measured power reaches the switching power value, the power not being increased any further and the blade angle being set by a or the speed regulator which regulates the speed by adjusting the blade angle, and/or
the boost power, the prevailing power loss and/or the predetermined power loss limit being considered as a loading criterion, and/or
the transition operating characteristic curve being set on the basis of the loading criterion and/or being chosen from a plurality of default operating characteristic curves, and/or
an increase in the speed to above nominal speed being permitted in the transition range, and/or
in the transition range, in addition to the transition operating characteristic curve, use being made of a speed-power characteristic curve which sets a power as a function of a measured speed, and/or
the speed-power characteristic curve being set on the basis of the loading criterion and/or being chosen from a plurality of default speed-power characteristic curves, and optionally
the transition operating characteristic curve being set on the basis of the chosen speed-power characteristic curve and/or being chosen from a plurality of default operating characteristic curves.

7. The method as claimed in claim 1, wherein
the power loss limit, the boost power and/or operational settings for operating the wind power installation at a power above the nominal power are/is determined
on the basis of a stator temperature of a stator of the generator, in particular additionally on the basis of a predetermined reference stator temperature and a specific thermal coefficient of the generator, in particular of the stator, and/or
are/is determined on the basis of a magnetic saturation of the generator.

8. The method as claimed in claim 1, wherein
the prevailing power loss is determined and the operation of the wind power installation at a power above the nominal power is controlled on the basis of the determined prevailing power loss, and
the prevailing power loss being determined in particular by means of a calculation rule, or being estimated.

9. The method as claimed in claim 1, wherein
the prevailing power loss is determined
on the basis of operational parameters which describe states of operation of the wind power installation, and/or
on the basis of properties of relevant components characterizing the power loss, in particular a temperature of the relevant component in each case, and/or
on the basis of environmental parameters which describe conditions in an environment of the wind power installation, in particular wind speed, outside temperature, humidity and/or air pressure.

10. The method as claimed in claim 1, wherein
the prevailing power loss and/or a component temperature are/is determined on the basis of an air gap thickness of the generator.

11. The method as claimed in claim 1, wherein,
for determining the prevailing power loss limit, operational parameters of a plurality of components of the wind power installation are considered, and
in particular the power loss limit is determined in such a way that the considered operational parameters do not exceed predetermined parameter limits,
in particular one, a plurality or all of the operational parameters from the following list being considered, the list comprising:
a generator temperature;
a temperature of an infeed unit;
a temperature of an electrical line, in particular a line between the generator and the infeed unit for transmitting electrical power from the generator to the infeed unit;
a temperature of an electrical inductor;
a temperature of a secondary circuit of an active cooling system;
a magnetization of the generator, a magnetic saturation being used as the predetermined parameter limit;
an electromagnetic force generated in the generator; and
a vibration amplitude of a mechanical vibration caused by the operation of the wind power installation.

12. The method as claimed in claim 1, wherein
the boost power, the prevailing power loss and/or the power loss limit, and/or the limit torque for the flapwise torque,
are/is determined on the basis of one, a plurality or all of the criteria from the list comprising:
a site of the wind power installation;
a wind direction;
time of day and/or time of year;
a turbulence intensity;
a wind shear;
an environmental temperature;
an air pressure; and
a humidity.

13. The method as claimed claim 1, wherein,
for operating the wind power installation at a power above the nominal power,
operational settings, in particular the blade angle, are set on the basis of the prevailing wind speed, and
on the basis of the boost power, the prevailing power loss and/or the power loss limit, and/or
the operational settings are determined by a calculation rule.

14. The method as claimed in claim 1, wherein,
for operating the wind power installation in a storm mode when the wind speed is above a predeterminable storm wind speed, a storm characteristic curve which specifies a correlation between speed and power is provided,
for controlling the wind power installation in a transition from full-load operation to storm mode when the wind power installation is operated in full-load operation at a power above the nominal power, a transition characteristic curve which specifies a correlation between speed and power, the correlation differing from the correlation according to the storm characteristic curve, is provided, in particular
the transition characteristic curve assigning higher power values to the same speed values in each case as compared to the storm characteristic curve.

15. A wind power installation having an aerodynamic rotor which is operable at variable speed and which has rotor blades which are adjustable in terms of their blade angle, and having a generator for generating a generator power, the wind power installation being distinguished by a nominal speed, a nominal power and a nominal wind speed at which the nominal speed and the nominal power are reached, and the wind power installation
having a control device for controlling the wind power installation, and
being set up to perform a method for controlling a wind power installation according to claim 1, in particular
the control device being set up to perform the method.
